(19) United States
(12) Patent Application Publication
(10) Pub. No.: US 2025/0243122 A1
(43) Pub. Date: Jul. 31, 2025

(54) FABRICATION OF POLYCRYSTALLINE SILICON NITRIDE FIBERS

(71) Applicant: BlueHalo, LLC, Huntsville, AL (US)

(72) Inventors: Hyunjun Kim, Huntsville, AL (US); Kristin A. Keller, Huntsville, AL (US)

(21) Appl. No.: 19/039,593

(22) Filed: Jan. 28, 2025

Related U.S. Application Data
(60) Provisional application No. 63/626,328, filed on Jan. 29, 2024.

(51) Int. Cl. C04B 35/587; C04B 35/622; C04B 35/626; C04B 35/63; C04B 35/645; D01F 9/08

(52) U.S. Cl. CPC C04B 35/587; C04B 35/62295; C04B 35/6261; C04B 35/62655; C04B 35/6268; C04B 35/6303; C04B 35/6455; D01F 9/08; C04B 2235/3222; C04B 2235/3225; C04B 2235/524; C04B 2235/6021; C04B 2235/606; C04B 2235/661; D10B 2101/14

(57) ABSTRACT

A method for creating polycrystalline silicon nitride fibers is discussed. The method includes dispersing silicon nitride powder to create dispersed silicon nitride powder. The dispersed silicon nitride powder is classified to create classified fine silicon nitride powder. Likewise, a sintering aid is dispersed to create a dispersed sintering aid and then classified to create a classified sintering aid. A plasticizer, a binder, and the classified sintering aid are added to the classified fine silicon nitride powder to define a compound. The compound is mixed to create a mixed slurry, which is then dried to create a material. The material is extruded through a nozzle that is less than 40 micrometers in diameter to create a preform, which is then sintered to create the polycrystalline silicon nitride fibers.

### CROSS-REFERENCE TO RELATED APPLICATIONS

This application claims priority to and benefit of U.S. Provisional Patent Application No. 63/626,328, filed on Jan. 29, 2024, the entire disclosure of which is hereby incorporated by reference.

### RIGHTS OF THE GOVERNMENT

The disclosure described herein may be manufactured and used by or for the Government of the United States for all governmental purposes without the payment of any royalty.

### FIELD OF TECHNOLOGY

The present disclosure relates to polycrystalline silicon nitride fibers and more specifically to polycrystalline silicon nitride fibers produced by extrusion methods.

### BACKGROUND

Silicon nitride (Si₃N₄) is a thermodynamically stable chemical compound with many desirable physical and optical properties. More specifically, silicon nitride is a high-melting-point solid that exhibits high thermal stability and is relatively chemically inert. Additionally, silicon nitride is very hard (e.g., 8.5 on the mohs scale) and exhibits strong optical nonlinearities, which make it suitable for all-optical applications. Due to these properties, silicon nitride is used in a wide range of applications, including but not limited to automotive applications (e.g., for engine parts), for bearings, or in any application that requires a high-temperature melting point processing, such as in metal cutting and the like.

The foregoing examples of the related art and limitations therewith are intended to be illustrative and not exclusive, and are not admitted to be “prior art.” Other limitations of the related art will become apparent to those of skill in the art upon a reading of the specification and a study of the drawings.

### BRIEF SUMMARY

The methods disclosed herein are directed to a process for creating polycrystalline silicon nitride (Si₃N₄) fibers. The process includes dispersing silicon nitride powder to create dispersed silicon nitride powder. The dispersed silicon nitride powder is then classified to create classified fine silicon nitride powder. Likewise, a sintering aid is dispersed to create a dispersed sintering aid and then classified to create a classified sintering aid. A plasticizer, a binder, and the classified sintering aid are added to the classified fine silicon nitride powder to define a compound. The compound is mixed to create a mixed slurry, which is then dried to create an extrudable material. The material is extruded through a nozzle that is less than 40 micrometers (μm) in diameter to create a preform, which is then sintered to create the polycrystalline silicon nitride fibers.

The above and other preferred features, including various novel details of implementation and combination of events, will now be more particularly described with reference to the accompanying figures and pointed out in the claims. It will be understood that the particular systems and methods described herein are shown by way of illustration only and not as limitations. As will be understood by those skilled in the art, the principles and features described herein may be employed in various and numerous embodiments without departing from the scope of any of the present inventions. As can be appreciated from the foregoing and the following description, each and every feature described herein, and each and every combination of two or more such features, is included within the scope of the present disclosure provided that the features included in such a combination are not mutually inconsistent. In addition, any feature or combination of features may be specifically excluded from any embodiment of any of the present inventions.

The foregoing Summary, including the description of some embodiments, motivations therefor, and/or advantages thereof, is intended to assist the reader in understanding the present disclosure, and does not in any way limit the scope of any of the claims.

### BRIEF DESCRIPTION OF THE DRAWINGS

The accompanying figures, which are included as part of the present specification, illustrate the presently preferred embodiments and together with the general description given above and the detailed description of the preferred embodiments given below serve to explain and teach the principles described herein.

FIG. 1 is a flowchart of a method for creating polycrystalline silicon nitride fibers by means of extrusion, in accordance with some embodiments.

FIG. 2 is a scanning electron microscope (SEM) micrograph showing a preform of a silicon nitride fiber, in accordance with some embodiments.

FIG. 3 is an SEM micrograph of the preform shown in FIG. 2 magnified ten times, in accordance with some embodiments.

FIG. 4 is an SEM micrograph of a sintered silicon nitride fiber extruded from a fifty micrometer nozzle, in accordance with some embodiments.

FIG. 5 is an SEM micrograph showing a cross sectional view of the silicon nitride fiber of FIG. 4, in accordance with some embodiments.

While the present disclosure is subject to various modifications and alternative forms, specific embodiments thereof have been shown by way of example in the drawings and will herein be described in detail. The present disclosure should not be understood to be limited to the particular forms disclosed, but on the contrary, the intention is to cover all modifications, equivalents, and alternatives falling within the spirit and scope of the present disclosure.

### DETAILED DESCRIPTION

Processes described herein are for fabricating polycrystalline silicon nitride (Si₃N₄) fibers. According to some embodiments, silicon nitride powder is dispersed and classified, and a sintering aid is dispersed and classified. The classified silicon nitride powder and classified sintering aid are then combined with a plasticizer and a binder to create a slurry that is dried while being agitated to produce a dried slurry with a desired viscosity. The dried slurry is then extruded via a nozzle with a diameter of 40 micrometers (μm) or less to create a preform of the silicon nitride fiber. The preform is then sintered to create the polycrystalline silicon nitride fiber.

The method described herein produces fibers with smaller diameters than what was previously considered possible for silicon nitride. That is, the method described herein can produce polycrystalline silicon nitride fibers with a diameter that can easily match the diameter of fibers produced by other materials, such as carboxymethylcellulose. For example, the disclosed method can produce polycrystalline silicon nitride fibers with the same diameter as existing carboxymethylcellulose fibers, which can be about 15 μm in diameter. Additionally, the sintered polycrystalline silicon nitride fibers produced with the methods described herein also have an additional advantage, they do not suffer from strength degradation like the amorphous silicon nitride fibers. This is because the silicon nitride fibers produced herein are dense, void-free, and do not experience re-crystallization which degrades strength at elevated temperatures.

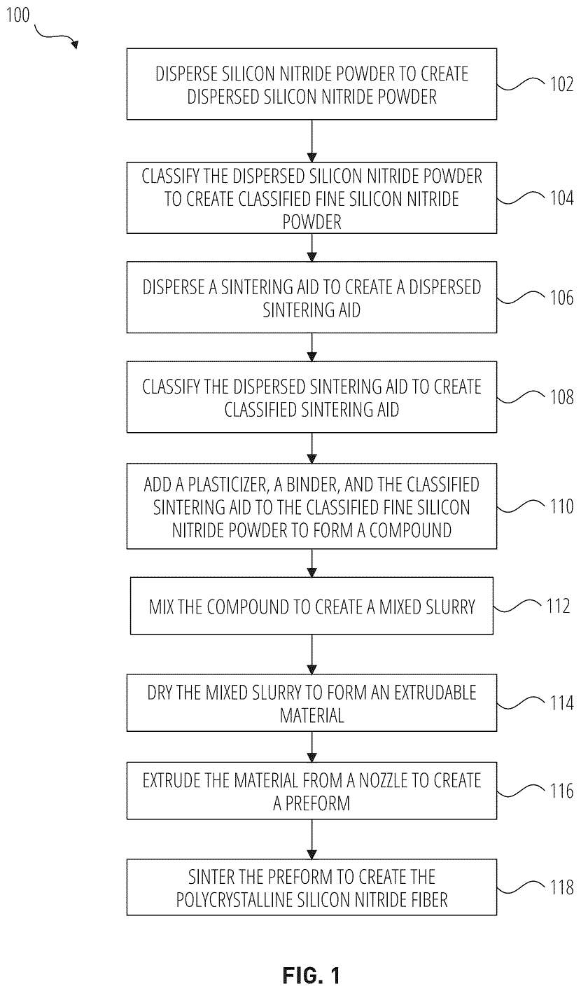

FIG. 1 is a flowchart of a method 100 for fabricating polycrystalline silicon nitride fibers, according to some embodiments. Method 100 begins at step 102 where silicon nitride powder is dispersed to create dispersed silicon nitride powder. For example, a suitable solvent (e.g., water, organic solvents, etc.) may be added to the silicon nitride powder. The silicon nitride powder may be then milled to disperse the silicon nitride powder within the solvent. By way of example and not limitation, ball milling, adhesion milling, attrition milling, etc., or combinations thereof may be used to disperse the silicon nitride powder. Additionally, any suitable milling media may be used (e.g., aluminum balls, silicon nitride balls, and the like).

At step 104, the dispersed silicon nitride powder is classified to create classified fine silicon nitride powder. In some implementations, classifying the dispersed silicon nitride powder can involve using sedimentation (e.g., via a centrifuge, gravity, etc.) to separate the dispersed silicon nitride powder into a sediment and a supernatant. For example, if a centrifuge is used, the centrifuge can be operated at five thousand revolutions per minute for about a minute.

The fine particles found suspended in the supernatant are separated from the liquid of the supernatant in the form of a fine silicon nitride powder. According to some embodiments, the fine particles have a diameter that is less than the diameter of the nozzle used for extrusion at a later step. For example, if a 40 μm nozzle is going to be used for the extrusion, the fine silicon nitride powder have a diameter less than 40 μm. Similarly, if a 20 μm nozzle is going to be used, the fine silicon nitride powder have a diameter less than 20 μm, and so on. According to some embodiments, the average size of the fine particles produced by method 100 is well below the diameter of the nozzle used for the extrusion. In some implementations, an average particle size of the fine silicon nitride powder could be 600 nanometers (nm) for a 40 μm diameter nozzle, 260 nm for a 30 μm diameter nozzle, 155 nm for a 20 μm diameter nozzle, etc.

In some implementations, a centrifuge may be used to separate the fine particles from the supernatant. By way of example and not limitation, the centrifuge may be operated at 13,000 revolutions per minute (13,000 rpm) for thirty minutes to classify the dispersed silicon nitride powder in a bottle. Then, clear water is decanted to obtain the fine dispersed silicon nitride powder particles at the bottom of the bottle. In some embodiments, this classifying process reduces the amount of time required for subsequent steps. The aforementioned operating conditions for the centrifuge are not limiting, and other operational conditions (e.g., speed and time) can be used achieve separation of the fine particles from the supernatant. Additionally, other suitable methods may be used to separate the fine particles from the supernatant, including filtering with a press filter, a Buchner funnel, and the like.

Method 100 continues to step 106 where a sintering aid is dispersed to create a dispersed sintering aid. Sintering aids include, but are not limited to, metal oxide powders, metalloid oxide powders, and the like. For example, yttrium aluminum garnet powder, aluminum oxide powder, dispersing yttrium oxide powder, silicon oxide powder, silicon dioxide powder, other rare earth metal oxides, etc., or combinations thereof may be used as the sintering aid. In some embodiments, the sintering aid is a single powder such as yttrium aluminum garnet powder. In other embodiments, more than one powder can be used as the sintering aids. In some embodiments, when more than one sintering aids are used, these sintering aids may be dispersed together or separately.

As with the dispersing of the silicon nitride powder discussed at step 102, dispersing the sintering aid may include adding a solvent (e.g., water, organic solvents, etc.) to the sintering aid. The sintering aid may be milled to disperse the sintering aid within the solvent. For example, ball milling, adhesion milling, attrition milling, etc., or combinations thereof may be used to disperse the silicon nitride powder. Moreover, any suitable milling media may be used (e.g., alumina balls, silicon nitride balls, etc.) without limitation. When multiple sintering aids are used (e.g., two), a first sintering aid can be combined with a second sintering aid to create a combined sintering aid. A solvent is added to the combined sintering aid, which is then milled to create the dispersed sintering aid.

At step 108, the dispersed sintering aid is classified to create a classified sintering aid. Any of the techniques discussed above in reference to classifying the silicon nitride may be used to classify the dispersed sintering aid. For example, the sintering aid may be classified using sedimentation via a centrifuge, gravity, etc. For example, if a centrifuge is used, the centrifuge can be operated at 5,000 rpms for about four to five minutes. Further, the classified sintering aid may be separated from the liquid of the supernatant using the same methods discussed above for the silicon nitride powder. Alternatively, the sintering aid may be the classified sintering aid slurry itself, without separating from the supernatant.

At step 110, a plasticizer (e.g., glycerol), a binder (e.g., METHOCEL™ ceramic binder), and the classified sintering aid are added to the classified silicon nitride powder to form a compound. In some examples, the compound may include two parts classified sintering aid to at least eight parts by weight of classified fine silicon nitride powder. Further, the compound may include five parts by weight of the plasticizer and binder combined. Thus, in this example, the compound is at most five parts plasticizer and binder together, at most two parts classified sintering aid, and at least eight parts classified fine silicon nitride powder by weight. However, it is noted that the above portions are not limiting. For example, more than eight parts of classified fine silicon nitride powder are possible.

At step 112, the compound is mixed to create a mixed slurry. Although, any suitable tools may be used to mix the compound, such as vacuum-capable or atmospheric planetary mixers, mixing under vacuum offers numerous benefits including elimination of unsightly voids in the slurry, improvement of dispersion quality, degassing (densification), and enhanced drying at lower temperatures to name a few. Vacuum refers to space in which pressure is lower than atmospheric pressure. In other words, it contains less gas molecules per unit volume compared to ambient air. In some embodiments, the mixing is terminated once the desired viscosity for the slurry is met.

At step 114, the mixed slurry is dried to create an extrudable material. For example the mixed slurry may be dried by agitating the mixed slurry under vacuum using an impeller, a spinning container, or the like. Drying with agitation reduces clumps that may form during the drying process. Once a desired viscosity is reached for the material, the drying process is terminated. When water is used as the solvent or for other purposes, the water is removed (e.g., vaporized) and the slurry is dried slowly—preferably with agitation as described above.

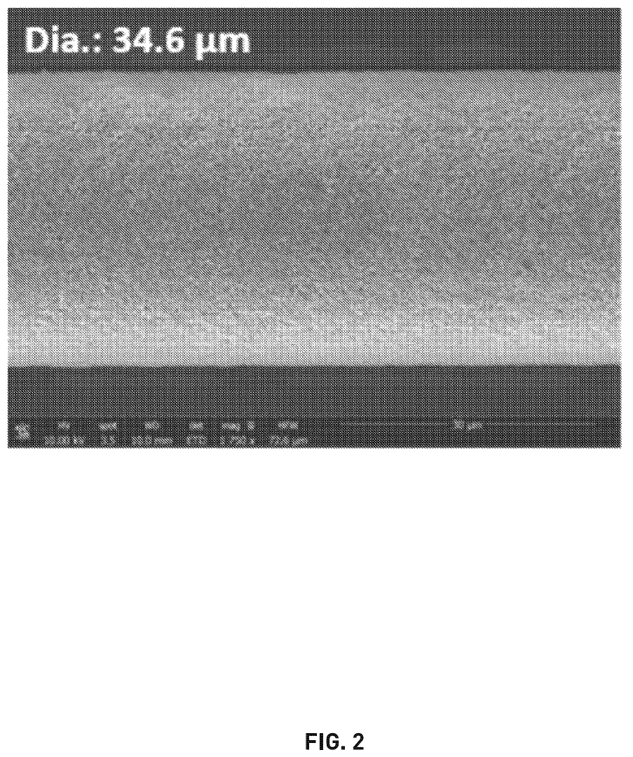

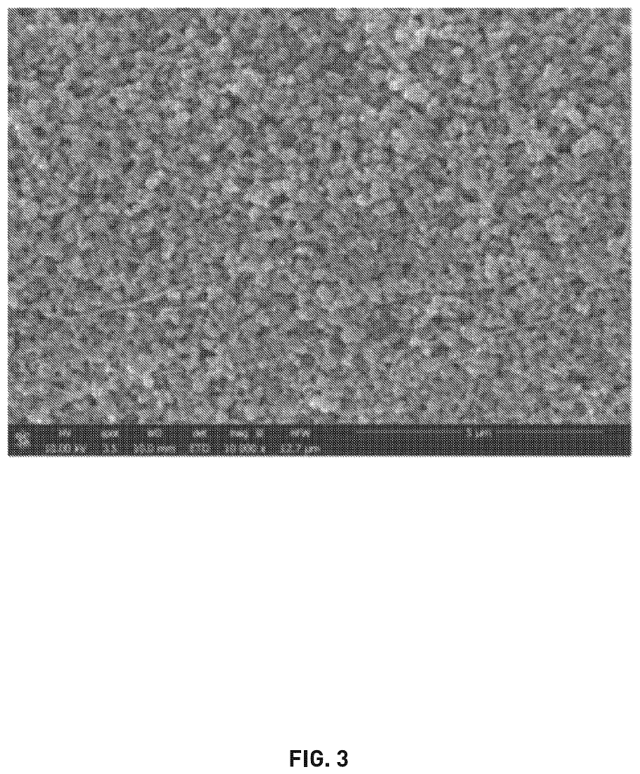

At step 116, the material is extruded through a nozzle, which according to some embodiments has a diameter of 40 μm or less, to create a preform. In some embodiments, the nozzle's diameter is 40 μm. In further embodiments, the nozzle's diameter is 30 μm. In other embodiments, the nozzle's diameter is 20 am. In some embodiments, the nozzle diameters is anywhere between 20 μm and 40 μm. As discussed above, the size of the nozzle's diameter limits the size of the classified particles (silicon nitride and sintering aid particles) as discussed above. According to some embodiments, FIG. 2 is a scanning electron microscope (SEM) micrograph of a preform extruded from a nozzle having a 40 μm diameter. FIG. 3 is an SEM micrograph of the preform shown in FIG. 2 at ten times (10×) the magnification.

In some embodiments, the preform is extruded onto a turntable that turns as the preform is extruded. A dryer apparatus, such as an infrared lamp, may dry the preform as it is extruded onto the turntable so that when the preform touches the turntable, the preform is dry. In some embodiments, the weight of the preform helps to straighten out the preform as it is extruded. It is noted that the distance between the nozzle's extrusion point and the turntable's surface on which the dried preform is disposed is a critical parameter. For example if the distance between the nozzle's extrusion point and the top surface of the turntable is too great, the preform may break under its own weight.

Referring back to FIG. 1, method 100 continues to step 118 where the preform is sintered to create the polycrystalline silicon nitride fiber. In some implementations, the preform is sintered in a nitrogen ambient for one hour at 1,700° C. In other embodiments, the sintering temperature may be between 1,600° C. and 1,700° C. In some embodiments, during sintering, the ambient temperature is ramped at a rate of 20° C. per minute (° C./min). Although the final silicon nitride fiber may shrink during sintering, the shrinkage is isotropic, and thus, the sintering itself does not induce any stress to the fiber.

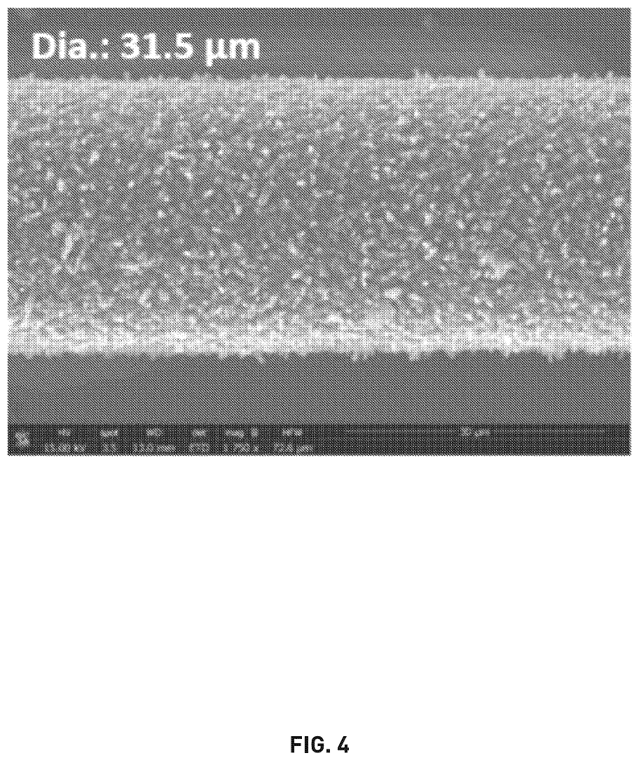

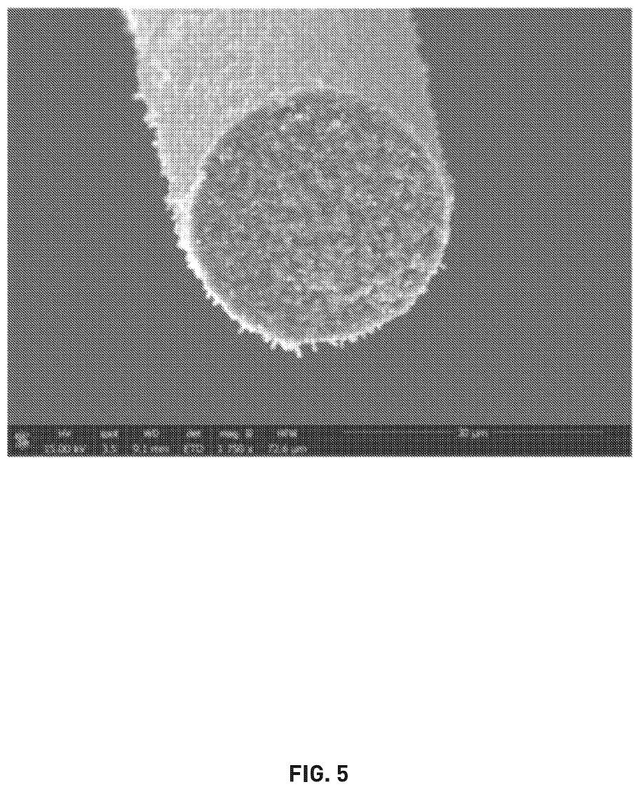

According to some embodiments, FIG. 4 is an SEM micrograph of a sintered polycrystalline silicon nitride fiber fabricated using a nozzle with a 50 μm diameter. FIG. 5 is an SEM micrograph of a cross-sectional view of the sintered polycrystalline silicon nitride fiber shown in FIG. 4. In some embodiments, the polycrystalline silicon nitride fibers are examined to determine its porosity levels. If the fiber's porosity is outside a predetermined threshold range, the fiber is processed further in a hot isostatic press. In some embodiments the desired fiber porosity may depend on specific use requirements.

The flowchart in FIG. 1 of method 100 illustrates the architecture, functionality, and operation of possible implementations of systems, methods and computer program products according to various embodiments of the present disclosure. In this regard, each step in the flowchart may represent a module, segment, or portion of code, which comprises one or more executable instructions for implementing the specified logical function(s). It should also be noted that, in some alternative implementations, the functions noted in the step may occur out of the order noted in FIG. 1. For example, two steps shown in succession may, in fact, be executed substantially concurrently, or the steps may sometimes be executed in the reverse order, depending upon the functionality involved. It will also be noted that each step of the flowchart illustration can be implemented by special purpose hardware-based systems that perform the specified functions or acts, or combinations of special purpose hardware and computer instructions.

### Some Embodiments

Some embodiments may include any of the following:
A.1. A method for creating a polycrystalline silicon nitride fiber, the method includes dispersing silicon nitride powder to create a dispersed silicon nitride powder and classifying the dispersed silicon nitride powder to create a classified fine silicon nitride powder. The method further includes, dispersing a sintering aid to create a dispersed sintering aid and classifying the dispersed sintering aid to create a classified sintering aid. The method also includes, adding a plasticizer, a binder, and the classified sintering aid to the classified fine silicon nitride powder to define a compound, mixing the compound to create a mixed slurry, drying the mixed slurry to create a material for extrusion, and extruding the material to create a preform, where the material is extruded through a nozzle that is less than 40 micrometers (μm) in diameter. Finally, sintering the preform to form the polycrystalline silicon nitride fiber.
A.2. The method of clause A.1 can include any of the following components or features, in any combination. Dispersing the silicon nitride powder includes adding a solvent to the silicon nitride powder, and after adding the solvent, milling the silicon nitride powder to disperse the silicon nitride powder within the solvent. Classifying the dispersed silicon nitride powder includes using a sedimentation method. Dispersing the sintering aid includes dispersing one or more metal oxide powders, where dispersing the one or more metal oxide powders includes dispersing an yttrium aluminum garnet powder, an aluminum oxide powder, or an yttrium oxide powder. The method may also include where dispersing the sintering aid includes dispersing a metalloid oxide powder. The method may also include where dispersing the sintering aid to create the dispersed sintering aid includes adding a solvent to the sintering aid, and after adding the solvent, milling the sintering aid to disperse the sintering aid within the solvent. The method may also include where dispersing the sintering aid to create the dispersed sintering aid includes combining a first sintering aid and a second sintering aid to create a combined sintering aid, adding a solvent to the combined sintering aid, and after adding the solvent, milling the combined sintering aid to disperse the combined sintering aid in the solvent. The method may also include where classifying the dispersed sintering aid to create the classified sintering aid includes classifying the dispersed sintering aid with a sedimentation method. The method may also include where adding the plasticizer, the binder, and the classified sintering aid to the classified fine silicon nitride powder to define the compound includes adding at most two parts of the classified sintering aid to at least eight parts of the classified fine silicon nitride powder by weight. The method may also include where adding the plasticizer, the binder, and the classified sintering aid to the classified fine silicon nitride powder to define the compound further includes adding at most five parts by weight of the plasticizer and the binder combined so that a resulting compound contains at most five parts plasticizer and binder, at most two parts classified sintering aid, and at least eight parts of the classified fine silicon nitride powder by weight. The method may also include where drying the mixed slurry includes agitating the mixed slurry under vacuum. The method may also include where extruding the material to create the preform includes extruding the material through a nozzle having a diameter between 20 and 30 μm. The method may also include where extruding the material to create the preform includes extruding the material through a nozzle having a diameter of 20 μm. The method may further include determining whether a porosity of the polycrystalline silicon nitride fiber is within a desired range, and in response to the porosity being outside the desired range, sintering the polycrystalline silicon nitride fiber in a hot isostatic press. The method may also include where classifying the dispersed silicon nitride powder to create classified fine silicon nitride powder includes separating particles suspended in a supernatant from a liquid of the supernatant to create the classified fine silicon nitride powder. The method may also include where extruding the material to create the preform includes drying the extruded material with a dryer apparatus to create the preform and disposing the preform on a turntable surface prior to the preform being sintered. The method may also include where a distance between an extrusion point of the nozzle and the turntable is predetermined to prevent the preform from breaking. Other technical features may be readily apparent to one skilled in the art from the following figures, descriptions, and claims.

### ADDITIONAL CONSIDERATIONS

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the invention in the form disclosed. Many modifications and variations will be apparent to those of ordinary skill in the art without departing from the scope and spirit of the invention. Aspects of the disclosure were chosen and described in order to best explain the principles of the invention and the practical application, and to enable others of ordinary skill in the art to understand the invention for various embodiments with various modifications as are suited to the particular use contemplated.

Measurements, sizes, amounts, and the like may be presented herein in a range format. The description in range format is provided merely for convenience and brevity and should not be construed as an inflexible limitation on the scope of the invention. Accordingly, the description of a range should be considered to have specifically disclosed all the possible subranges as well as individual numerical values within that range. For example, description of a range such as 1-20 meters should be considered to have specifically disclosed subranges such as 1 meter, 2 meters, 1-2 meters, less than 2 meters, 10-11 meters, 10-12 meters, 10-13 meters, 10-14 meters, 11-12 meters, 11-13 meters, etc.

Reference in the specification to “one embodiment,” “preferred embodiment,” “an embodiment,” “some embodiments,” or “embodiments” means that a particular feature, structure, characteristic, or function described in connection with the embodiment is included in at least one embodiment of the invention and may be in more than one embodiment. Also, the appearance of the above-noted phrases in various places in the specification is not necessarily referring to the same embodiment or embodiments.

The use of certain terms in various places in the specification is for illustration purposes only and should not be construed as limiting. A service, function, or resource is not limited to a single service, function, or resource; usage of these terms may refer to a grouping of related services, functions, or resources, which may be distributed or aggregated.

Furthermore, one skilled in the art shall recognize that: (1) certain steps may optionally be performed; (2) steps may not be limited to the specific order set forth herein; (3) certain steps may be performed in different orders; and (4) certain steps may be performed simultaneously or concurrently.

The term “approximately”, the phrase “approximately equal to”, and other similar phrases, as used in the specification and the claims (e.g., “X has a value of approximately Y” or “X is approximately equal to Y”), should be understood to mean that one value (X) is within a predetermined range of another value (Y). The predetermined range may be plus or minus 20%, 10%, 5%, 3%, 1%, 0.1%, or less than 0.1%, unless otherwise indicated.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements).

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements).

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic disks, magneto-optical disks, optical disks, or solid state drives. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including, by way of example, semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse, a trackball, a touchpad, or a stylus, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

In some embodiments, aspects of the systems and methods described herein may be implemented using ML and/or AI technologies.

“Machine learning” generally refers to the application of certain techniques (e.g., pattern recognition and/or statistical inference techniques) by computer systems to perform specific tasks. Machine learning techniques may be used to build models based on sample data (e.g., “training data”) and to validate the models using validation data (e.g., “testing data”). The sample and validation data may be organized as sets of records (e.g., “observations” or “data samples”), with each record indicating values of specified data fields (e.g., “independent variables,” “inputs,” “features,” or “predictors”) and corresponding values of other data fields (e.g., “dependent variables,” “outputs,” or “targets”). Machine learning techniques may be used to train models to infer the values of the outputs based on the values of the inputs. When presented with other data (e.g., “inference data”) similar to or related to the sample data, such models may accurately infer the unknown values of the targets of the inference data set.

As used herein, “model” may refer to any suitable model artifact generated by the process of using a machine learning algorithm to fit a model to a specific training data set. The terms “model,” “data analytics model,” “machine learning model” and “machine learned model” are used interchangeably herein.

As used herein, the “development” of a machine learning model may refer to construction of the machine learning model. Machine learning models may be constructed by computers using training data sets. Thus, “development” of a machine learning model may include the training of the machine learning model using a training data set. In some cases (generally referred to as “supervised learning”), a training data set used to train a machine learning model can include known outcomes (e.g., labels or target values) for individual data samples in the training data set. For example, when training a supervised computer vision model to detect images of cats, a target value for a data sample in the training data set may indicate whether or not the data sample includes an image of a cat. In other cases (generally referred to as “unsupervised learning”), a training data set does not include known outcomes for individual data samples in the training data set.

Following development, a machine learning model may be used to generate inferences with respect to “inference” data sets. For example, following development, a computer vision model may be configured to distinguish data samples including images of cats from data samples that do not include images of cats. As used herein, the “deployment” of a machine learning model may refer to the use of a developed machine learning model to generate inferences about data other than the training data.

“Artificial intelligence” (AI) generally encompasses any technology that demonstrates intelligence. Applications (e.g., machine-executed software) that demonstrate intelligence may be referred to herein as “artificial intelligence applications,” “AI applications,” or “intelligent agents.” An intelligent agent may demonstrate intelligence, for example, by perceiving its environment, learning, and/or solving problems (e.g., taking actions or making decisions that increase the likelihood of achieving a defined goal). In many cases, intelligent agents are developed by organizations and deployed on network-connected computer systems so users within the organization can access them. Intelligent agents are used to guide decision-making and/or to control systems in a wide variety of fields and industries, e.g., security; transportation; risk assessment and management; supply chain logistics; and energy management. Intelligent agents may include or use models.

Some non-limiting examples of AI application types may include inference applications, comparison applications, and optimizer applications. Inference applications may include any intelligent agents that generate inferences (e.g., predictions, forecasts, etc.) about the values of one or more output variables based on the values of one or more input variables. In some examples, an inference application may provide a recommendation based on a generated inference. For example, an inference application for a lending organization may infer the likelihood that a loan applicant will default on repayment of a loan for a requested amount, and may recommend whether to approve a loan for the requested amount based on that inference. Comparison applications may include any intelligent agents that compare two or more possible scenarios. Each scenario may correspond to a set of potential values of one or more input variables over a period of time. For each scenario, an intelligent agent may generate one or more inferences (e.g., with respect to the values of one or more output variables) and/or recommendations. For example, a comparison application for a lending organization may display the organization's predicted revenue over a period of time if the organization approves loan applications if and only if the predicted risk of default is less than 20% (scenario #1), less than 10% (scenario #2), or less than 5% (scenario #3). Optimizer applications may include any intelligent agents that infer the optimum values of one or more variables of interest based on the values of one or more input variables. For example, an optimizer application for a lending organization may indicate the maximum loan amount that the organization would approve for a particular customer.

Each numerical value presented herein, for example, in a table, a chart, or a graph, is contemplated to represent a minimum value or a maximum value in a range for a corresponding parameter. Accordingly, when added to the claims, the numerical value provides express support for claiming the range, which may lie above or below the numerical value, in accordance with the teachings herein. Absent inclusion in the claims, each numerical value presented herein is not to be considered limiting in any regard.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other steps or stages may be provided, or steps or stages may be eliminated, from the described processes. Accordingly, other implementations are within the scope of the following claims.

It will be appreciated by those skilled in the art that the preceding examples and embodiments are exemplary and not limiting to the scope of the present disclosure. It is intended that all permutations, enhancements, equivalents, combinations, and improvements thereto that are apparent to those skilled in the art upon a reading of the specification and a study of the drawings are included within the true spirit and scope of the present disclosure. It shall also be noted that elements of any claims may be arranged differently including having multiple dependencies, configurations, and combinations.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A method for creating a polycrystalline silicon nitride fiber, the method comprising:
dispersing silicon nitride powder to create a dispersed silicon nitride powder;
classifying the dispersed silicon nitride powder to create a classified fine silicon nitride powder;
dispersing a sintering aid to create a dispersed sintering aid;
classifying the dispersed sintering aid to create a classified sintering aid;
adding a plasticizer, a binder, and the classified sintering aid to the classified fine silicon nitride powder to define a compound;
mixing the compound to create a mixed slurry;
drying the mixed slurry to create a material for extrusion;
extruding the material to create a preform, wherein the material is extruded through a nozzle that is less than 40 micrometers (μm) in diameter; and
sintering the preform to form the polycrystalline silicon nitride fiber.

2. The method of claim 1, wherein dispersing the silicon nitride powder comprises:
adding a solvent to the silicon nitride powder; and
after adding the solvent, milling the silicon nitride powder to disperse the silicon nitride powder within the solvent.

3. The method of claim 1, wherein classifying the dispersed silicon nitride powder comprises using a sedimentation method.

4. The method of claim 1, wherein dispersing the sintering aid comprises dispersing one or more metal oxide powders.

5. The method of claim 4, wherein dispersing the one or more metal oxide powders comprises dispersing an yttrium aluminum garnet powder.

6. The method of claim 4, wherein dispersing metal oxide powder comprises dispersing an aluminum oxide powder.

7. The process of claim 4, wherein dispersing metal oxide powder comprises dispersing an yttrium oxide powder.

8. The method of claim 1, wherein dispersing the sintering aid comprises dispersing a metalloid oxide powder.

9. The method of claim 1, wherein dispersing the sintering aid to create the dispersed sintering aid comprises:
adding a solvent to the sintering aid; and
after adding the solvent, milling the sintering aid to disperse the sintering aid within the solvent.

10. The method of claim 1, wherein dispersing the sintering aid to create the dispersed sintering aid comprises:
combining a first sintering aid and a second sintering aid to create a combined sintering aid;
adding a solvent to the combined sintering aid; and
after adding the solvent, milling the combined sintering aid to disperse the combined sintering aid in the solvent.

11. The method of claim 1, wherein classifying the dispersed sintering aid to create the classified sintering aid comprises classifying the dispersed sintering aid with a sedimentation method.

12. The method of claim 1, wherein adding the plasticizer, the binder, and the classified sintering aid to the classified fine silicon nitride powder to define the compound comprises adding at most two parts of the classified sintering aid to at least eight parts of the classified fine silicon nitride powder by weight.

13. The method of claim 12, wherein adding the plasticizer, the binder, and the classified sintering aid to the classified fine silicon nitride powder to define the compound further comprises adding at most five parts by weight of the plasticizer and the binder combined so that a resulting compound contains at most five parts plasticizer and binder, at most two parts classified sintering aid, and at least eight parts of the classified fine silicon nitride powder by weight.

14. The method of claim 1, wherein drying the mixed slurry comprises agitating the mixed slurry under vacuum.

15. The method of claim 1, wherein extruding the material to create the preform comprises extruding the material through a nozzle having a diameter between 20 and 30 μm.

16. The method of claim 1, wherein extruding the material to create the preform comprises extruding the material through a nozzle having a diameter of 20 μm.

17. The method of claim 1, further comprising:
determining whether a porosity of the polycrystalline silicon nitride fiber is within a desired range; and
in response to the porosity being outside the desired range, sintering the polycrystalline silicon nitride fiber in a hot isostatic press.

18. The method of claim 1, wherein classifying the dispersed silicon nitride powder to create classified fine silicon nitride powder comprises separating particles suspended in a supernatant from a liquid of the supernatant to create the classified fine silicon nitride powder.

19. The method of claim 1, wherein extruding the material to create the preform comprises drying the extruded material with a dryer apparatus to create the preform and disposing the preform on a turntable surface prior to the preform being sintered.

20. The method of claim 19, wherein a distance between an extrusion point of the nozzle and the turntable is predetermined to prevent the preform from breaking.
